(19) United States
(12) Patent Application Publication
(10) Pub. No.: US 2011/0019032 A1
(43) Pub. Date: Jan. 27, 2011

(54) METHOD AND APPARATUS FOR MULTI-SPECTRAL IMAGING

(75) Inventors: Ephraim Pinsky, Kiriyat Tivon (IL); Ramy Leber, Manof (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: RAFAEL ADVANCED DEFENSE SYSTEMS LTD., Haifa (IL)

(21) Appl. No.: 12/864,530

(22) PCT Filed: Dec. 31, 2008
(86) PCT No.: PCT/IB08/55597

§ 371 Date: Oct. 10, 2010

(30) Foreign Application Priority Data
Jan. 24, 2008 (IL) 189020

(51) Int. Cl. H04N 9/68; G06K 9/00

(52) U.S. Cl. 348/238; 382/162; 348/E09.053

(57) ABSTRACT

A multi-spectral video camera and corresponding method have an optical arrangement for collecting light, a light splitting prism for splitting the light into a number of spatially separated channels of distinct spectral ranges, and a corresponding number of image sensor arrays. An electronic control and processing system receives sensed pixel data from each of image sensor arrays, analyzes the pixel data separately for each of the image sensor arrays to determine an exposure parameter for each of the sensor arrays, and actuates each of the sensor arrays to capture a subsequent image frame with an effective exposure individually set for each sensor array in accordance with the corresponding exposure parameter. The camera also preferably performs independent contrast enhancement corrections for each spectral channel of the camera.

### FIELD AND BACKGROUND OF THE INVENTION

The present invention relates to imaging techniques in which two or more colors or spectral ranges are recorded. In particular, the invention relates to devices and methods for independent control of the exposure for each channel, and/or where contrast enhancement processing is performed on each of the channels separately.

It is known to capture digital images in which two or more colors or spectral ranges are recorded. The most prevalent example is color photography in which red, green and blue (“RGB”) color separations are recorded for each image (frame) and are recombined to generate a “true color” representation of the scene.

It has also been found useful to employ other forms of multi-spectral imaging, typically with some or all of the spectral ranges lying outside the visible spectrum, either in the infrared or ultraviolet regions. This allows extraction of additional information which is not visible to the human eye, for example, where different parts of the scene have similar reflectivity in the visible range and exhibit different reflectivities at some other wavelength. Depending on the intended application, multi-spectral imaging may have any number of distinct channels from two upwards. The present invention relates primarily, although not exclusively, to applications with between 2 and 10 distinct channels, and most typically 3-5 channels. For display to a human user, it is common to map the information from various non-visible spectral ranges into visible colors, producing what is referred to as a “false color” display. Exemplary applications of multi-spectral imaging include astronomical research, agriculture, archeology, quality control and surveillance, as well as various medical and military applications.

A digital image sensor inherently has a limited dynamic range. If too much radiation reaches the sensor, the corresponding pixels reach saturation and fail to provide further information. If, on the other hand, too little radiation reaches the sensor, no image data will be recorded, or the data will be spread between a relatively low number of intensity levels with consequent loss of information or poor quality of the image. The data is normally kept within the dynamic range of the sensor by appropriate adjustment of the duration of exposure and/or other parameters affecting the sensitivity of the sensor. This adjustment may be performed optically, i.e., by a mechanical or electro-optical shutter deployed in the optical system, or electronically by controlling the electrical signals to the image sensor array which define the integration time of the pixel sensors. The adjustment is typically performed collectively for all of the colors or spectral ranges.

In various circumstances, the exposure adjustment may result in non-optimal use of the dynamic range of the sensor for one or more spectral range when the exposure is adjusted for all channels to avoid over-exposure in one particular channel. By way of example, when a color video camera is turned towards a bright blue sky, important information visible in the red and green color separations may be lost due to the short exposure time necessitated to avoid saturation in the blue color channel.

There is therefore a need for methods and devices for sampling multi-spectral, video images where the exposure of each channel is independently dynamically adjusted and/or where a contrast enhancement correction is independently and dynamically applied to each channel.

### SUMMARY OF THE INVENTION

The present invention provides methods and devices for sampling multi-spectral video images where the exposure of each channel is independently dynamically adjusted and/or where a contrast enhancement correction is independently and dynamically applied to each channel.

According to the teachings of the present invention there is provided, a method for sampling multi-spectral video images of a dynamically changing scene, the method comprising the steps of: (a) providing a multi-spectral imaging device including a plurality of image sensor arrays, each of the sensor arrays being deployed for sampling sequences of image frames of the changing scene within a distinct predefined spectral range; (b) during ongoing sampling of the image frames, deriving for each of the sensor arrays an exposure parameter determined by applying at least one exposure criterion to pixel values in at least one frame sampled by the sensor array; and (c) setting independently for each of the sensor arrays an effective exposure for a subsequent sampled frame of the sequence of image frames, the effective exposure being set in accordance with the exposure parameter for the corresponding sensor array.

According to a further feature of the present invention, the multi-spectral imaging device includes at least three of the image sensor arrays deployed for sampling spectral ranges corresponding to color separations for constructing a true color video sequence of the changing scene.

According to a further feature of the present invention, pixel values for a plurality of the image frames are scaled by a correction coefficient related to the effective exposures so as to correct a color balance between the color separations from each of the image sensor arrays.

According to a further feature of the present invention, a contrast enhancement correction is applied to a plurality of the image frames from each of the image sensor arrays, the contrast enhancement correction being performed independently for each of the spectral ranges.

According to a further feature of the present invention, the effective exposure is set for each sampled frame from each sensor array based on the measure of current dynamic range derived from exactly one frame previously sampled by the sensor array.

According to a further feature of the present invention, the at least one exposure criterion is applied to pixel values in at least one frame preceding the sampled frame by no more than a fifth of a second.

There is also provided according to the teachings of the present invention, a method for sampling multi-spectral video images of a dynamically changing scene, the method comprising the steps of: (a) providing a multi-spectral imaging device configured for sampling sequences of image frames in each of a plurality of channels, each of the channels corresponding to a distinct predefined spectral range; (b) during ongoing sampling of the image frames, applying a contrast enhancement correction to a plurality of the image frames from each of the channels, wherein the contrast enhancement correction is performed independently for each of the channels.

According to a further feature of the present invention, the corrected image frames are output for display as a real-time corrected video sequence.

According to a further feature of the present invention, the multi-spectral imaging device includes a plurality of image sensor arrays, each of the sensor arrays being deployed for sampling sequences of image frames of the changing scene within a distinct predefined spectral range.

According to further features of the present invention: (a) during ongoing sampling of the image frames, for each of the sensor arrays, an exposure parameter is derived determined by applying at least one exposure criterion to pixel values in at least one frame sampled by the sensor array; and (b) for each of the sensor arrays, an effective exposure is set independently for a subsequent sampled frame of the sequence of image frames, the effective exposure being set in accordance with the exposure parameter for the corresponding sensor array.

There is also provided according to the teachings of the present invention, multi-spectral video camera for capturing video images of a dynamically changing scene comprising: (a) an optical arrangement for collecting light from the changing scene; (b) a light splitting prism configured for splitting the light from the optical arrangement into a plurality of spatially separated channels each containing light of a distinct predefined spectral range; (c) a plurality of image sensor arrays, each of the sensor arrays being deployed for sampling a sequence of image frames for a corresponding one of the channels; and (d) an electronic control system associated with the plurality of image sensor arrays, the electronic control system including at least one processor, the electronic control system being configured to: (i) receive sensed pixel data from each of the image sensor arrays, (ii) analyze the pixel data separately for each of the image sensor arrays so as to determine an exposure parameter for each of the sensor arrays, and (iii) actuate each of the sensor arrays to capture a subsequent image frame with an effective exposure individually set for each sensor array in accordance with the corresponding exposure parameter.

According to a further feature of the present invention, the light splitting prism is configured for splitting the light from the optical arrangement into channels with spectral ranges corresponding to color separations for constructing a true color video sequence of the changing scene.

According to a further feature of the present invention, the electronic control system is further configured to scale pixel values for each of the image frames by a correction coefficient related to the effective exposures so as to correct a color balance between the color separations from each of the image sensor arrays.

According to a further feature of the present invention, the electronic control system is further configured to apply a contrast enhancement correction to each of the image frames from each of the image sensor arrays, the contrast enhancement correction being performed independently for each of the color separations.

According to a further feature of the present invention, the electronic control system is further configured to apply a contrast enhancement correction to each of the image frames from each of the image sensor arrays, the contrast enhancement correction being performed independently for each of the channels.

According to a further feature of the present invention, the electronic control system is further configured to set the effective exposure for each sampled frame from each channel based on the exposure parameter derived from exactly one frame previously sampled by the sensor array.

According to a further feature of the present invention, the at least one exposure criterion is applied to pixel values in at least one frame preceding the sampled frame by no more than a fifth of a second.

There is also provided according to the teachings of the present invention, multi-spectral video camera for capturing video images of a dynamically changing scene comprising: (a) a multi-spectral imaging device configured for sampling sequences of image frames in each of a plurality of channels, each of the channels corresponding to a distinct predefined spectral range; and (b) an electronic control system associated with the multi-spectral imaging device, the electronic control system including at least one processor, the electronic control system being configured to: (i) receive pixel data for image frames in each of the channels, (ii) during ongoing sampling of the image frames, apply a contrast enhancement correction to a plurality of the image frames from each of the channels, wherein the contrast enhancement correction is performed independently for each of the channels.

According to a further feature of the present invention, the electronic control system is further configured to output the corrected image frames for display as a real-time corrected video sequence.

According to a further feature of the present invention, the multi-spectral imaging device includes: (a) a light splitting prism configured for splitting the light from the optical arrangement into a plurality of spatially separated channels each containing light of a distinct predefined spectral range; and (b) plurality of image sensor arrays, each of the sensor arrays being deployed for sampling a sequence of image frames for a corresponding one of the channels.

According to a further feature of the present invention, the electronic control system is further configured to: (a) during ongoing sampling of the image frames, derive for each of the sensor arrays an exposure parameter determined by applying at least one exposure criterion to pixel values in at least one frame sampled by the sensor array; and (b) set independently for each of the sensor arrays an effective exposure for a subsequent sampled frame of the sequence of image frames, the effective exposure being set in accordance with the exposure parameter for the corresponding sensor array.

There is also provided according to the teachings of the present invention, multi-spectral camera for capturing images of a scene comprising: (a) an optical arrangement for collecting light from the scene; (b) a light splitting prism configured for splitting the light from the optical arrangement into a plurality of spatially separated channels each containing light of a distinct predefined spectral range; (c) a plurality of image sensor arrays, each of the sensor arrays being deployed for sampling image frames for a corresponding one of the channels; and (d) an electronic control system associated with the plurality of image sensor arrays, the electronic control system including at least one processor, the electronic control system being configured to: (i) receive sensed pixel data from each of the image sensor arrays, (ii) analyze the pixel data separately for each of the image sensor arrays so as to determine an exposure parameter for each of the sensor arrays, and (iii) actuate each of the sensor arrays to capture a subsequent image frame with an effective exposure individually set for each sensor array in accordance with the corresponding exposure parameter.

### BRIEF DESCRIPTION OF THE DRAWINGS

The invention is herein described, by way of example only, with reference to the accompanying drawings, wherein:

FIG. 1 is a schematic representation of a multi-spectral video camera, constructed and operative according to the teachings of the present invention;

FIG. 2 is functional block diagram of the multi-spectral video camera of FIG. 1;

FIG. 3 is a flow diagram illustrating the operation of the multi-spectral video camera of FIG. 1; and

FIGS. 4A and 4B are three-dimensional histograms of the distribution of pixel values in three-dimensional color space before and after a contrast enhancement correction according to an aspect of the present invention, respectively.

### DESCRIPTION OF THE PREFERRED EMBODIMENTS

The present invention is a method and device for sampling multi-spectral video images where the exposure of each channel is independently dynamically adjusted and/or where a contrast enhancement correction is independently and dynamically applied to each channel.

The principles and operation of methods and devices according to the present invention may be better understood with reference to the drawings and the accompanying description.

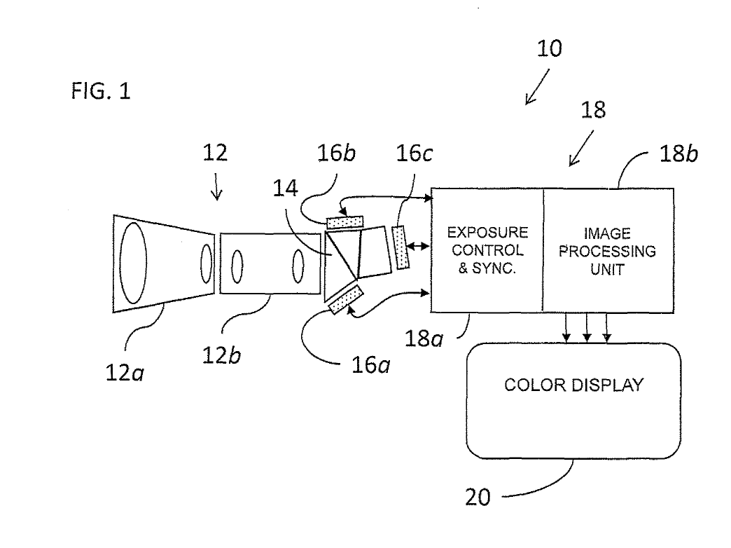

Referring now to the drawings, FIGS. 1-3 illustrate the structure and function of a multi-spectral video camera, and the corresponding method, according to the teachings of the present invention.

By way of introduction, before addressing the features of the present invention in detail, it should be noted that the present invention provides two distinct aspects, each of which is of significance in its own right, and which are most preferably used in synergy to provide a particularly advantageous device and method. The first aspect relates to an implementation of a multi-spectral video camera and corresponding method in which exposure times for each image sensor array are dynamically varied in an individual manner for each spectral channel. The second aspect relates to an implementation of a multi-spectral video camera in which a contrast enhancement correction is performed independently and dynamically for each channel of the multi-spectral output. Although these two aspects will be described herein primarily with reference to a preferred embodiment which combines them, it will be clear to one ordinarily skilled in the art that each of the above aspects of the invention is of independent utility.

Referring now to FIG. 1, there is shown a multi-spectral video camera, generally designated 10, for capturing video images of a changing scene. Addressing first the aspect of independent exposure control, generally speaking, video camera 10 includes an optical arrangement 12 for collecting light from the changing scene, a light splitting prism 14 configured for splitting the light from the optical arrangement into a plurality of spatially separated channels each containing light of a distinct predefined spectral range, and a plurality of image sensor arrays 16a, 16b and 16c, each deployed for sampling a sequence of image frames for a corresponding one of the channels. An electronic control system 18, including at least one processor, is configured to: (a) receive sensed pixel data from each of image sensor arrays 16a, 16b and 16c; (b) analyze the pixel data separately for each of the image sensor arrays so as to determine an exposure parameter for each of sensor arrays 16a, 16b and 16c; and (c) actuate each of sensor arrays 16a, 16b and 16c to capture a subsequent image frame with an effective exposure individually set for each sensor array in accordance with the corresponding exposure parameter.

At this stage, it will already be clear that multi-spectral video camera 10 and its mode of operation, corresponding to a method of the present invention, provide profound advantages over the common exposure control adjustment prevalent in the prior art. Specifically, by adjusting the exposure time for the sensor array of each spectral channel individually in real-time on the basis of pixel values previously sampled from the same sensor array, the dynamic range of each sensor array is near-optimally utilized and the information content of the images is thus enhanced. This and other advantages of the present invention will become clearer from the following detailed description.

Before addressing the features of the invention in more detail, it will be helpful to define certain terminology as used herein in the description and claims. Firstly, the term “multi-spectral” is used herein in the description and claims to refer to any imaging technique which simultaneously samples images in at least two distinct predefined spectral ranges. These spectral ranges may be of any width, may be overlapping or nested, and may lie anywhere in the optical radiation band ranging from infrared through visible light to ultraviolet. Examples of multi-spectral imaging according to this definition include, but are not limited to: true-color video imaging; green-red-infrared imaging; and imaging techniques using multiple infrared wavelengths. The invention relates primarily, although not exclusively, to multi-spectral techniques employing 2-10 distinct spectral ranges, and most typically 3-5 spectral ranges.

The term “true color” is used to refer to a subset of multi-spectral techniques in which three spectral bands are sampled in the visible spectrum to allow reproduction of images which approximate to a faithful reproduction of a scene as viewed by the human eye, typically corresponding directly to the red-green-blue (RGB) bands to which the human eye is sensitive. In such applications, each of the channels may be referred to as a “color separation”.

The term “video” is used herein in the description and claims to refer to any imaging process which generates a sequence of image frames at a constant frame rate over a period of time. For multi-spectral video, the output typically has synchronous frames for each of the spectral channels. Depending on the particular application, and the capabilities of the sensor arrays used for each channel, the frame rates do not necessarily have to be frame rates which are normally referred to as continuous video. For most applications, however, frame rates of at least about 25-30 frames per second are used in order to provide a visual impression of continuous motion between the frames.

Where reference is made to adjustments or events occurring in “real-time”, the intent is to adjustments or events occurring within a time frame perceived by a user to be immediate or almost immediate. Thus, by way of example, for many applications, a video display of captured images may be considered acceptably “real-time” if it lags behind the true scene by a few tenths of a second. In most cases, the real-time adjustments of the present invention occur within a timeframe of less than one tenth of a second.

The phrase “image sensor array” is used to refer to any image sensor array suited for use for imaging the corresponding spectral range. Where possible, preferred implementations use low-cost mass-produced on-chip sensor arrays such as CCD or CMOS sensors. Where required, mixed types of sensor arrays may be used for the different spectral channels.

The term “effective exposure” is used herein to refer to any adjustable parameter which determines the exposure time or “integration time” for sampling an image frame by a given image sensor array, or which achieves a result equivalent to varying the exposure time.

The term “contrast enhancement correction” is used to refer to any image processing technique which enhances the visual perceptibility of small changes between intensity values of pixels. Typically, contrast enhancement corrections adjust pixel intensity values so as to spread the distribution of pixel values across a wider range of values within the dynamic range of the image. A large range of techniques for contrast enhancement are known in the art, and do not per se constitute part of the present invention. The contrast enhancement techniques may be applied either locally on different regions of the image and then combined to a complete scene, or may be applied globally on the entire image.

Finally, where reference is made to adjustments or corrections made “independently” for each spectral channel, this refers to adjustments or corrections which achieve an individually-tailored result for each channel as opposed to being identical for all channels. The term “independently” does not necessarily exclude cases where some part of the process is performed commonly for plural channels, or where some degree of correlation is imposed between the channels. Thus, for example, a correction or adjustment may in some cases be performed commonly on all channels, and then selected channels may be subject to an additional individual correction or adjustment, thereby achieving the result of an independent correction or adjustment for all channels.

Turning now to the features of multi-spectral video camera 10 and the associated method in more detail, optical arrangement 12, light splitting prism 14 and image sensor arrays 16a, 16b and 16c may be any suitable assembly of components for generating the required type of multi-spectral video images, and are typically standard camera components for the relevant type of multi-spectral (e.g., color) video camera. Thus, by way of non-limiting example, optical arrangement 12 as shown here includes an objective lens arrangement 12a and may also include an optical relay 12b. Light splitting prism 14 is shown here schematically for the case of a three-channel application as a trichroic prism assembly of a type commonly used in three-chip video cameras, although any arrangement for generating spatial separation between the different spectral channels of interest may be used. For true-color applications, light splitting prism 14 is configured for splitting the light from the optical arrangement into channels with spectral ranges corresponding to color separations for constructing a true color video sequence of the changing scene, typically RGB.

The number and type of image sensor arrays 16a, 16b and 16c are chosen according to the number of spectral channels and their wavelength ranges, all as will be clear to one ordinarily skilled in the art.

Turning now to electronic control system 18, this typically includes a camera control subsystem 18a which handles input/output functions of the sensor arrays, providing trigger signals for synchronization of frames, control of exposure times and other operating parameters. Electronic control system 18 also preferably includes an image processing subsystem 18b. It will be appreciated by one ordinarily skilled in the art that the subdivision of processing functions between physical parts of the system may vary widely, and that many aspects of the processing system may be implemented as various different combinations of hardware, software and firmware. By way of example, particularly in the case of CMOS image sensor arrays, various processing functions may be integrated directly onto the image sensor chips themselves. Thus, the recited electronic control system refers to the presence of suitable electronic components at any location within the system which perform the particular recited functions further detailed below.

Electronic control system 18 is also associated with an output device which may be a color display 20 as shown here. Additionally, or alternatively, the output may be directed to another device, such as a communications system for transmission to a remote location, a data storage device, or another processing system for further analysis of the collected data.

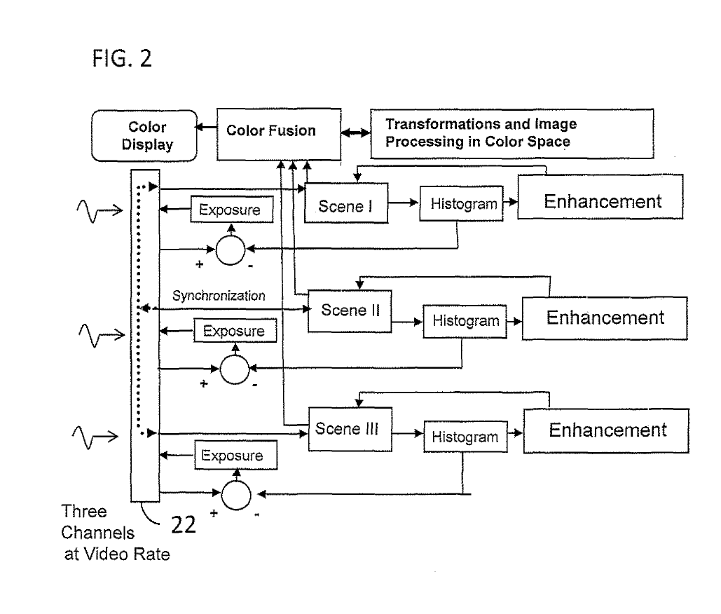

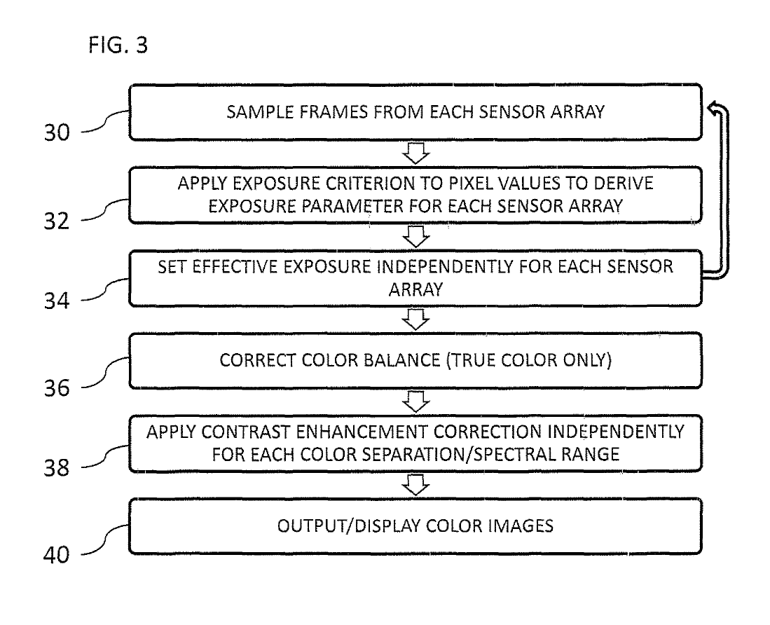

The operation of electronic control system 18, and the corresponding method of the present invention, will now be described with reference to FIGS. 2 and 3. In FIG. 2, box 22 represents schematically the combination of optical arrangement 12, light splitting prism 14 and image sensor arrays 16a, 16b and 16c which together generate sets of three synchronous frames of the same image in the respective spectral channels. These frames are stored, respectively, as “Scene I”, “Scene II” and “Scene III”. In FIG. 3, this corresponds to sampling of frames from each sensor array, identified as step 30. Then at step 32, during ongoing sampling of the image frames, the system applies an exposure criterion to the pixel values of at least one frame from each sensor array to derive an exposure parameter for each sensor array. The “exposure parameter” here is a parameter which gives an indication of whether the frame in question is overexposed, underexposed, or within an acceptable range of exposure. In the example illustrated in FIG. 2, this involves the system deriving from each of the frames a corresponding histogram of intensity values of the pixels. Various straightforward algorithms may then be applied to the histogram to generate an exposure parameter, as is well known in the art. By way of one particularly simple and effective non-limiting example, the average black level of the scene may be calculated and, based on this result, the exposure time required to achieve a desired average black level can be derived. Then at step 34, a desired effective exposure for a subsequent sampled frame of the sequence of image frames is set independently for each of the sensor arrays in accordance with the aforementioned exposure parameter for the corresponding sensor array. In other words, if the effective exposure for the prior frame of a given spectral channel was overexposed, the effective exposure for the subsequent frame of that spectral channel is shortened, and conversely where the prior frame was underexposed the effective exposure is lengthened. This is represented in FIG. 2 by a feedback connection to an exposure setting arrangement for each of sensor arrays. Steps 30, 32 and 34 are preferably performed continuously in a closed-loop to provide real-time independent exposure adjustment for each separate spectral channel. This ensures that each spectral channel adapts rapidly to variations of scene intensity within the relevant spectral range to keep each sensor array operating within its optimal dynamic range.

Depending upon the available processing resources, the effective exposure adjustment need not necessarily be performed at the frame rate of the video. In many cases, an adjustment of the exposure once every few frames would provide an acceptably rapid adjustment to accommodate sudden changes in illumination or scene brightness without sufficient delay to disturb a user watching the output. Similarly, for many applications, it is not critical whether the frame or frames from which the exposure parameter is derived is immediately prior to, or several frames prior to, the subsequent frame for which the exposure is being corrected. Typically, a delay of up to about a fifth of a second in applying the exposure correction is not critical. However, in a particularly preferred high-performance implementation of the present invention, the effective exposure for each sampled frame from each channel is set based on the exposure parameter derived from the immediately previous frame sampled by the sensor array.

As mentioned earlier, the present invention is applicable both to true-color imaging and other types of multi-spectral imaging. Specifically in the case of true-color applications, the independent adjustment of exposure for the different channels raises an issue of distorting color balance between the color separations. To restore the color balance, at step 36, the processing system preferably scales pixel values for each of the image frames by a gain correction coefficient related to the effective exposures (typically inversely proportional to the exposure time) so as to correct the color balance between the color separations from each of the image sensor arrays. In order to avoid loss of information during this scaling, the bit depth (number of shades per pixel) for each frame may be increased about the native bit depth of the sensor output, all as will clear to one ordinarily skilled in the art.

Turning now to features related to the second aspect of the present invention, it is a particular feature of certain implementations of the present invention that electronic control system 18 is further configured to apply a contrast enhancement correction to each of the image frames from each of the image sensor arrays, the contrast enhancement correction being performed independently for each of the channels. This is shown in FIG. 3 as step 38, and corresponds to the block labeled “Enhancement” associated with each channel in FIG. 2. Algorithms for performing contrast enhancement are per se well known, and will not be dealt with here in detail. Typically, for whole-frame contrast enhancement, a pixel intensity value spreading operator is applied to the frame with parameters derived from the histogram of pixel values of the frame as sampled. The effect of the operator is to spread the histogram more evenly through the available dynamic range.

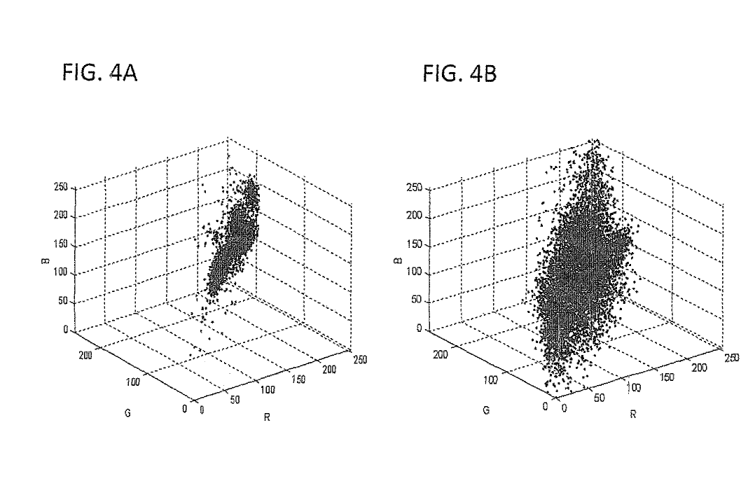

FIGS. 4A and 4B illustrate the importance of the application of a contrast enhancement correcting independently to each channel. FIG. 4A shows a three-dimensional histogram of pixel intensities within a sampled frame, where the axes correspond to 8-bit (256 level) pixel intensities in each of the RGB channels. In the particular case shown here, the range of values in red and green are fairly small, lying primarily in the 150-255 range, while the range of values in the blue channel (shown vertically) is much broader, spanning much of the dynamic range. If a contrast enhancement correction were applied uniformly to all channels, only a small correction could be made in order to avoid loss of information at the upper and lower ends of the dynamic range in the blue channel. By dealing separately with each channel, it is possible to optimize the contrast in each channel, as illustrated in FIG. 4B, so that the pixel values span substantially the entire dynamic range in each channel. This makes visual interpretation of the image data significantly easier.

It will be noted that, in true-color applications, the independent contrast enhancement for each channel may introduce some degree of color imbalance. However, particularly where accurate visual assessment of image features is of prime importance, the particularly vivid, high contrast resulting image may represent a worthwhile tradeoff against lack in fidelity of color reproduction.

As mentioned above, it will be noted that both the independent exposure control aspect and the independent contrast enhancement correction aspect of the present invention are considered useful and of patentable significance when used separately in an otherwise conventional system. Furthermore, the independent contrast correction aspect of the invention is not necessarily limited to cases where separate sensor arrays are used for each channel, and can be applied in any case where digitally separated (or otherwise electronically separated) color channels are available for individual processing, even if they originate from a single Bayer-filter color-sensor chip. In a particularly preferred implementation, the two aspects are combined in synergy, both contributing to the correctly distributed dynamic range of the resulting images.

Turning now to the remaining features shown in FIG. 2, after application of the contrast enhancement corrections to Scenes I, II and II, the corrected images are transferred for fusing into a color image format as part of a video sequence, which may be a true-color image or a synthesized “false-color” image according to the spectral channels used. These color images may be further processed or subject to transformations according to conventional techniques, depending on the details of the particular application, all as is known in the art. By way of one non-limiting example, a technique known in the art as PCA (Principal Component Analysis) may be applied to further transform the three-dimensional histogram of pixel intensities of a sampled frame so as to accomplish significant further enhancement. The color images are then output for display and/or other further processing, corresponding to step 40 in FIG. 3.

Although the above description relates to particularly preferred implementations of the present invention in the context of video photography, it should be noted that the principles of the present invention may also be applied in other contexts. For example, in the case of a high quality true color stills camera with separate sensor arrays for each color channel, the separate channel exposure control of the present invention may be used to advantage. In this case, the exposure setting for each channel would preferably be derived from readings taken during the pre-shot monitoring mode, or from a test-exposure taken just prior to the main image exposure. In such a ease, a color balance correction is also required, all as described above.

It will be appreciated that the above descriptions are intended only to serve as examples, and that many other embodiments are possible within the scope of the present invention as defined in the appended claims.

What is claimed is:

1. A method for sampling multi-spectral video images of a dynamically changing scene, the method comprising the steps of:
(a) providing a multi-spectral imaging device including a plurality of image sensor arrays, each of said sensor arrays being deployed for sampling sequences of image frames of the changing scene within a distinct predefined spectral range;
(b) during ongoing sampling of said image frames, deriving for each of said sensor arrays an exposure parameter determined by applying at least one exposure criterion to pixel values in at least one frame sampled by said sensor array; and
(c) setting independently for each of said sensor arrays an effective exposure for a subsequent sampled frame of said sequence of image frames, said effective exposure being set in accordance with said exposure parameter for the corresponding sensor array.

2. The method of claim 1, wherein said multi-spectral imaging device includes at least three of said image sensor arrays deployed for sampling spectral ranges corresponding to color separations for constructing a true color video sequence of the changing scene.

3. The method of claim 2, further comprising scaling pixel values for a plurality of said image frames by a correction coefficient related to said effective exposures so as to correct a color balance between said color separations from each of said image sensor arrays.

4. The method of claim 2, further comprising applying a contrast enhancement correction to a plurality of said image frames from each of said image sensor arrays, said contrast enhancement correction being performed independently for each of said color separations.

5. The method of claim 1, further comprising applying a contrast enhancement correction to a plurality of said image frames from each of said image sensor arrays, said contrast enhancement correction being performed independently for each of said spectral ranges.

6. The method of claim 1, wherein said effective exposure is set for each sampled frame from each sensor array based on said measure of current dynamic range derived from exactly one frame previously sampled by said sensor array.

7. The method of claim 1, wherein said at least one exposure criterion is applied to pixel values in at least one frame preceding said sampled frame by no more than a fifth of a second.

8. A method for sampling multi-spectral video images of a dynamically changing scene, the method comprising the steps of:
(a) providing a multi-spectral imaging device configured for sampling sequences of image frames in each of a plurality of channels, each of said channels corresponding to a distinct predefined spectral range;
(b) during ongoing sampling of said image frames, applying a contrast enhancement correction to a plurality of said image frames from each of said channels,
wherein said contrast enhancement correction is performed independently for each of said channels.

9. The method of claim 8, further comprising outputting said corrected image frames for display as a real-time corrected video sequence.

10. The method of claim 8, wherein said multi-spectral imaging device includes a plurality of image sensor arrays, each of said sensor arrays being deployed for sampling sequences of image frames of the changing scene within a distinct predefined spectral range.

11. The method of claim 10, further comprising:
(a) during ongoing sampling of said image frames, deriving for each of said sensor arrays an exposure parameter determined by applying at least one exposure criterion to pixel values in at least one frame sampled by said sensor array; and
(b) setting independently for each of said sensor arrays an effective exposure for a subsequent sampled frame of said sequence of image frames, said effective exposure being set in accordance with said exposure parameter for the corresponding sensor array.

12. A multi-spectral video camera for capturing video images of a dynamically changing scene comprising:
(a) an optical arrangement for collecting light from the changing scene;
(b) a light splitting prism configured for splitting the light from the optical arrangement into a plurality of spatially separated channels each containing light of a distinct predefined spectral range;
(c) a plurality of image sensor arrays, each of said sensor arrays being deployed for sampling a sequence of image frames for a corresponding one of said channels; and
(d) an electronic control system associated with said plurality of image sensor arrays, said electronic control system including at least one processor, said electronic control system being configured to:
(i) receive sensed pixel data from each of said image sensor arrays,
(ii) analyze said pixel data separately for each of said image sensor arrays so as to determine an exposure parameter for each of said sensor arrays, and
(iii) actuate each of said sensor arrays to capture a subsequent image frame with an effective exposure individually set for each sensor array in accordance with the corresponding exposure parameter.

13. The multi-spectral video camera of claim 12, wherein said light splitting prism is configured for splitting the light from the optical arrangement into channels with spectral ranges corresponding to color separations for constructing a true color video sequence of the changing scene.

14. The multi-spectral video camera of claim 13, wherein said electronic control system is further configured to scale pixel values for each of said image frames by a correction coefficient related to said effective exposures so as to correct a color balance between said color separations from each of said image sensor arrays.

15. The multi-spectral video camera of claim 13, wherein said electronic control system is further configured to apply a contrast enhancement correction to each of said image frames from each of said image sensor arrays, said contrast enhancement correction being performed independently for each of said color separations.

16. The multi-spectral video camera of claim 12, wherein said electronic control system is further configured to apply a contrast enhancement correction to each of said image frames from each of said image sensor arrays, said contrast enhancement correction being performed independently for each of said channels.

17. The multi-spectral video camera of claim 12, wherein said electronic control system is further configured to set said effective exposure for each sampled frame from each channel based on said exposure parameter derived from exactly one frame previously sampled by said sensor array.

18. The multi-spectral video camera of claim 12, wherein said at least one exposure criterion is applied to pixel values in at least one frame preceding said sampled frame by no more than a fifth of a second.

19. A multi-spectral video camera for capturing video images of a dynamically changing scene comprising:
(a) a multi-spectral imaging device configured for sampling sequences of image frames in each of a plurality of channels, each of said channels corresponding to a distinct predefined spectral range; and
(b) an electronic control system associated with said multi-spectral imaging device, said electronic control system including at least one processor, said electronic control system being configured to:
(i) receive pixel data for image frames in each of said channels,
(ii) during ongoing sampling of said image frames, apply a contrast enhancement correction to a plurality of said image frames from each of said channels,
wherein said contrast enhancement correction is performed independently for each of said channels.

20. The multi-spectral video camera of claim 19, wherein said electronic control system is further configured to output said corrected image frames for display as a real-time corrected video sequence.

21. The multi-spectral video camera of claim 19, wherein said multi-spectral imaging device includes:
(a) a light splitting prism configured for splitting the light from the optical arrangement into a plurality of spatially separated channels each containing light of a distinct predefined spectral range; and
(b) a plurality of image sensor arrays, each of said sensor arrays being deployed for sampling a sequence of image frames for a corresponding one of said channels.

22. The multi-spectral video camera of claim 21, wherein said electronic control system is further configured to:
(a) during ongoing sampling of said image frames, derive for each of said sensor arrays an exposure parameter determined by applying at least one exposure criterion to pixel values in at least one frame sampled by said sensor array; and
(b) set independently for each of said sensor arrays an effective exposure for a subsequent sampled frame of said sequence of image frames, said effective exposure being set in accordance with said exposure parameter for the corresponding sensor array.

23. A multi-spectral camera for capturing images of a scene comprising:
(a) an optical arrangement for collecting light from the scene;
(b) a light splitting prism configured for splitting the light from the optical arrangement into a plurality of spatially separated channels each containing light of a distinct predefined spectral range;
(c) a plurality of image sensor arrays, each of said sensor arrays being deployed for sampling image frames for a corresponding one of said channels; and
(d) an electronic control system associated with said plurality of image sensor arrays, said electronic control system including at least one processor, said electronic control system being configured to:
(i) receive sensed pixel data from each of said image sensor arrays,
(ii) analyze said pixel data separately for each of said image sensor arrays so as to determine an exposure parameter for each of said sensor arrays, and
(iii) actuate each of said sensor arrays to capture a subsequent image frame with an effective exposure individually set for each sensor array in accordance with the corresponding exposure parameter.
